(19) United States
(12) Patent Application Publication
(10) Pub. No.: US 2003/0104872 A1
(43) Pub. Date: Jun. 5, 2003

(54) Cardan shaft joint

(75) Inventors: Vladimir Petrovich Lobozov, Moscow (RU); Konstantin Zakharovich Shepelyakovsky, Moscow (RU); Sergei Ivanovich Nikitin, Moscow (RU); Anatoly Alexeevich Kuznetsov, Moscow (RU); Victor Ivanovich Kravchenko, Grodno (BY); Leonard Iosifovich Derechenik, Grodno (BY); Gennady Alexandrovich Kostyukovich, Grodno (BY); Alexandr Matveevich Gagasov, Minsk (BY)

Correspondence Address: ANDERSON KILL & OLICK, P.C., 1251 AVENUE OF THE AMERICAS, NEW YORK, NY, 10020, US

(73) Assignee: Zakrytoye aktsionernoye obschestvo "TEKHMASH" (RU)

(21) Appl. No.: 10/006,683

(22) Filed: Dec. 10, 2001

(30) Foreign Application Priority Data
Dec. 4, 2001 (RU) 2001-109606

(51) Int. Cl. F16D 3/16; F16D 3/20; F16D 3/26; F16D 3/50

(52) U.S. Cl. 464/128

(57) ABSTRACT

The invention relates to mechanical engineering, more particularly, cardan shaft joints and can be used in transmissions of various vehicles.

The task of the invention is to create a cardan shaft joint possessing a high durability, necessary and prescribed reliability and contact strength, with a reduction of its cost at the same time.

For the task to be fulfilled, the cardan shaft joint is comprised of a cross with a needle bearing mounted on each and every pin thereof, the cross, outer ring and the needle rollers of the needle bearing being made of a structural carbon steel having a lower hardenability, and along with this, a carbon content in the structural steel selected for manufacturing the cross and outer ring of the needle bearing is the same while the carbon content in the structural steel selected for manufacturing the needle rollers is 1.21-1.33 of the carbon contained in the structural steel selected for making the cross and outer ring of the needle bearing. Also, the microstructure of the surface layer of cross pins, the entire volume of the outer ring and needle rollers of the needle bearing represents a martensite tempered with the size of the effective austenitic grain being from 0.0027 to 0.0069 mm. Moreover, the microstructure of the surface layer of the outer ring of the needle bearing is a martensite tempered with the size of the effective austenitic grain being from 0.0027 to 0.0069 mm while the microstructure of the core of the needle bearing outer ring is an acicular troostite having a hardness ranging from 44 to 47 HRC, and the microstruoture of the core of pins and the cross body is troostite, troostosorbite or sorbite and, more importantly, the surface hardness of the needle rollers of the needle bearing exceeds the hardness of the cross pins surface and that of the outer ring of the needle bearing 2-3 HRC.

The present invention relates to mechanical engineering, namely cardan shaft joints and can be used in transmissions of various vehicles.

Known in the art is a cardan shaft joint including a cross with a needle bearing mounted on each and every pin thereof (cf. USSR inventorship certificate No 1832083, 1993). However, the known cardan shaft joint has insufficient durability and reliability and also poor contact fatigue strength; its cost is high owing to the use, for the manufacture of parts thereof, of construction steels, such as steel, containing 0.95-1.05% C, 0.17-0.37% Si, 0.2-0.4% Mn, 1.3-1.65% Cr, ≦0.3% Ni and ≦0.25% Cu, and low-alloy construction case-hardened steels, such as steel, containing 0.18-0.24% C, 0.17-0.37% Si, 0.8-1.1% Mn, 0.4-0.7% Cr, 0.4-0.7% Ni, 0.03-0.09% Ti and ≦0.3% Cu.

The technical task of the invention is to create a cardan shaft joint free of the above-listed drawbacks and featuring a high durability and also necessary and prescribed reliability and contact fatigue strength, with a reduced cost thereof at the same time.

A technical result is achieved owing to the fact that in the proposed cardan shaft joint comprising a cross with a needle bearing mounted on every pin thereof, a distinctive specific feature resides in making the cross, the outer ring and needle rollers of the needle bearing from a carbon construction steel having a lower hardenability and, along with this, the carbon content in the construction steel chosen for manufacturing the cross and the outer ring of the needle bearing is equal while the carbon content in the construction steel chosen for manufacturing the needle rollers is 1.21-1.33 of the carbon content in the construction steel chosen for making the cross and the outer ring of the needle bearing. Also, the microstructure of the surface layer of the cross's pins, the entire volume of the outer ring and the needle bearing needle rollers is a tempered martensite with an austenitic effective grain size varying from 0.0027 to 0.0069 mm. And the microstructure of the surface layer of the outer ring of the needle bearing is a tempered martensite with an austenitic effective grain size ranging from 0.0027 to 0.0069 mm, while the microstructure of the inner layer of the outer ring of the neddle bearing is a troostite having a hardness of 44-47 HRC. Further, the microstructure of the core of pins and the cross body is troostite, troostosorbite or sorbite, with a hardness of the surface of the needle bearing needle rollers exceeding in 2-3 HRC that of the cross pins and the outer ring of the needle bearing.

The experimental bench and then full-scale comparison tests of the proposed and known designs of a cardan shaft joint have shown that the use of all the distinctive features resulted in creating the cardan shaft joint construction displaying a 18-20% increased durability, a necessary prescribed reliability and a 20-25% improved contact fatigue strength when used within the cardan shafts of automobiles having a different load-carrying capacity, with a concurrently achieved considerable reduction of the cost of the cardan shaft joint, for which protection is being sought.

The comparison tests for the contact fatigue strength of the conventional and claimed constructions of a cardan shaft joint were conducted in recurrent cycles, with the testing estimated time of 105 hours under the following conditions:

| | | | | | |
|---|---|---|---|---|---|
| M twist., | 4790 | 3687 | 2107 | 1318 | 921 |
| N m | | | | | |
| n, min⁻¹ | 500 | 500 | 1000 | 1500 | 1800 |
| time, min | 1 | 1 | 3 | 7 | 15 |

Tests for durability were conducted with a constant twisting moment till the temperature achieved on the surface of an outer ring is 90° C.

The comparison test results of the claimed and prior art constructions of a cardan shaft joint are given in the Table.

| Joint parts parameters | Conventional joint | Claimed joint |
|---|---|---|
| 1. Cross pin, dia., mm | 33.6 | 33.6 |
| 2. Number of needle rollers, pcs. | 29 | 29 |
| 3. Needle roller, dia., mm | 4.075 | 4.075 |
| 4. Outer ring wall, thickness, mm | 4.1 | 4.1 |
| 5. Material: | | |
| cross | steel, containing 0.18-0.24% | steel, containing |
| | C, 0.17-0.37% Si, 0.8-1.1% | 0.62% C, 0.1-0.3% Si, |
| | Mn, 0.4-0.7% Cr, 0.4-0.7% | ≦0.2% Mn, ≦0.15% Cr, |
| | Ni, 0.03-0.09% Ti, ≦0.3% | ≦0.3% Ni, ≦0.2% Cu, |
| | Cu. | ≦0.04% S, ≦0.035% P |
| needle roller | steel, containing 0.95-1.05% | steel, containing |
| | C, 0.17-0.37% Si, 0.2-0.4% | 0.80% C, 0.1-0.3% Si, |
| | Mn, 1.3-1.65% Cr, Ni ≦ 0.3%, | ≦0.2% Mn, ≦0.15% Cr, |
| | Cu ≦ 0.25%, ≦0.02% S, ≦ | ≦0.3% Ni, ≦0.2% Cu, |
| | 0.027% P | ≦0.04% S, ≦0.035% P |
| outer ring | steel, containing 0.12- | steel, containing |
| | 0.19% C, 0.17-0.37% Si, 0.8- | 0.62% C, 0.1-0.3% Si, |
| | 1.2% each Mn, Ni and Cr, | ≦0.2% Mn, ≦0.15% Cr, |
| | ≦0.3% Cu, ≦0.35% each S | ≦0.3% Ni, ≦0.2% Cu, |
| | and P | 0.04% S, ≦0.035% P |
| 6. Heat treatment | | |
| a) cross | case-hardening followed by | volume-surface |
| | hardening with furnace | hardening with tempering |
| | heating and oil cooling | |
| b) needle roller | hardening with furnace | volume-surface |
| | heating and oil cooling | hardening with furnace |
| | | tempering |
| c) outer ring | case-hardening followed by | volume-surface |
| | hardening with furnace | hardening with furnace |
| | heating and oil cooling | tempering |
| 7. Hardness, HRC: | | |
| a) cross pin surface | 60 . . . 61 | 61 . . . 62 |
| b) needle roller surface | 62 . . . 63 | 63 . . . 64 |
| c) outer ring inner | 61 . . . 62 | 61 . . . 62 |
| surface | | |
| d) outer ring core | — | 44 . . . 46 |
| 8. Microstructure: | | |
| a) cross: | | |
| surface layer | martensite fine needle + | martensite |
| | residual austenite | structureless tempered |
| pins core | troostite + ferrite | troostite |
| body | troostite + ferrite | troostosorbite |
| b) needle roller | martensite fine-needle | martenisite |
| | type + residual austenite | structureless tempered |
| c) outer ring: | | |
| surface layer | martensite average needle + | martensite |
| | residual austenite | structureless, tempered |
| core | troostite + ferrite | troostite fine-needle type |
| 9. Effective austenitic grain | | |
| size, mm: | | |
| cross | 0.099-0.0138 | 0.0049-0.0069 |
| needle roller | 0.0069-0.0099 | 0.0032-0.0049 |
| outer ring | 0.0099-0.0138 | 0.0032-0.0049 |
| 10. State of joint parts after | | |
| tests: | | |
| a) cross pins: | | |
| “pitting” of effective | 42-50 | 30-38 |
| area, % | | |
| b) needle rollers: | | |
| destructed, % | 2-4 | no |
| those featuring point | 11-13 | no |
| chipping, % | | |
| c) outer ring inner | | |
| surface: | | |
| “pitting” of effective area, % | 42-50 | 30-38 |
| 11. Durability of joint, hrs. | 405 | 479 |

The invention will now be described in detail with reference to the accompanying drawing illustrating a specific embodiment thereof, in which

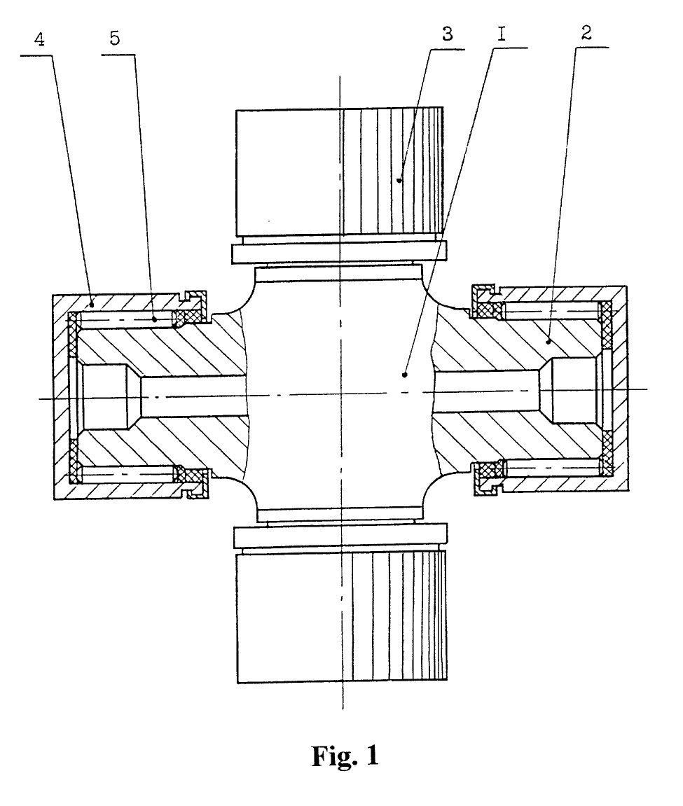

FIG. 1 is a general view of the standard-type cardan shaft joint as proposed.

The cardan shaft joint is comprised of a cross 1 with a needle bearing 3 mounted on every pin 2 thereof, which includes an outer ring 4 and needle rollers 5. The cross 1 of the joint and also the outer ring 4 and the needle rollers 5 of the needle bearing 3 are made from a structural carbon steel having a lower hardenability. The cross 1 of the joint and the outer ring 4 of its needle bearing 3 are made of the structural carbon steel with the same carbon content. To make the needle rollers 5 of the needle bearing 3, use is made of the structural carbon steel with a carbon content selected within the limits of 1.21-1.33 of the carbon contained in the steel which has been utilized to manufacture the cross 1 and the outer ring 4 of the needle bearing 3 and, along with this, in a surface layer of the pins 2 of the cross 1 of the joint and also in the entire volume of the outer ring 4 and the needle rollers 5 of the needle bearing 3 there is created a microstructure of a martensite tempered with the size of the effective austenitic grain being from 0.0027 to 0.0069 mm.

At the same time, the outer ring of a needle bearing in another embodiment has a microstructure of the surface layer in the form of a martensite tempered with the size of the effective austenitic grain being from 0.0027 to 0.0069 mm, and the microstructure of an inner layer—a troostite having a hardness of 44-47 HRC. The core of the pins 2 and the body of the cross 1 contain a microstructure of troostite, troostosorbite or sorbite. The surface hardness of the needle rollers 5 of the needle bearing 3 has been chosen to exceed 2-3 HRC the hardness of the surface of contact of the pins 2 of the cross 1 and the hardness of the surface of contact of the outer ring 4 of the needle bearing 3.

1. A cardan shaft joint including a cross with a needle bearing mounted on every pin thereof, wherein the cross, outer ring and the needle rollers of the needle bearing are made from a structural carbon steel having a lower hardenability, subjected to volume-surface hardening and tempering, and a carbon content in the structural steel selected for manufacturing the cross and outer ring of the needle bearing is equal while the carbon contained in the structural steel selected for making the needle rollers is 1.21-1.33 of the carbon contained in the structural steel selected for manufacturing the cross and the outer ring of the needle bearing.

2. The cardan shaft joint of claim 1, wherein the microstructure of the surface layer of the cross pins, the entire volume of the outer ring and the needle rollers of the needle bearing is a martensite tempered with the size of the effective austenitic grain being from 0.0027 to 0.0069 mm.

3. The cardan shaft joint of claim 1, wherein the microstructure of the surface layer of the cross pins, the needle rollers and the microstructure of the surface layer of the outer ring of the needle bearing is a martensite tempered with the size of the effective austenitic grain being from 0.0027 to 0.0069 mm while the microstructure of the core of the needle bearing outer ring is a troostite having a hardness varying from 44 to 47 HRC.

4. The cardan shaft joint of claim 1, wherein the microstructure of the core of pins and the cross body is troostite, troostosorbite or sorbite.

5. The cardan shaft joint of claim 1, wherein the surface hardness of the needle rollers of the needle bearing exceeds by 2-3 HRC the surface hardness of cross pins and that of the outer ring of the needle bearing.
